(19) United States
(12) Patent Application Publication
(10) Pub. No.: US 2019/0317380 A1
(43) Pub. Date: Oct. 17, 2019

(54) OPTICAL DEVICE, METHOD FOR MANUFACTURING OPTICAL DEVICE, AND WAVELENGTH CONVERSION METHOD

(71) Applicant: Sumitomo Electric Industries, Ltd., Osaka (JP)

(72) Inventors: Shigehiro NAGANO, Yokohama-shi (JP); Masato SUZUKI, Yokohama-shi (JP); Masato TANAKA, Yokohama-shi (JP); Manabu SHIOZAKI, Yokohama-shi (JP); Hiroo KANAMORI, Yokohama-shi (JP)

(73) Assignee: Sumitomo Electric Industries, Ltd., Osaka (JP)

(21) Appl. No.: 16/451,502

(22) Filed: Jun. 25, 2019

Related U.S. Application Data
(63) Continuation of application No. PCT/JP2017/023062, filed on Jun. 22, 2017.

(30) Foreign Application Priority Data
Dec. 28, 2016 (JP) 2016-255547

(51) Int. Cl. G02F 1/383; G02B 6/032; G02B 6/036

(52) U.S. Cl. CPC G02F 1/383; G02B 6/032; C03B 2201/40; C03B 2201/31; G02B 6/036

(57) ABSTRACT

The present embodiment relates to an optical device or the like that is high in non-linearity and resistance to UV light and includes a structure allowing stable wavelength conversion. The optical device is comprised of glass containing SiO₂ and comprises a repetitive structure including first sections being crystallized regions in which a radial polarization-ordered structure is formed and second sections being non-crystallized regions alternately arranged along a center axis extending from a center of a light-incidence end face toward a center of a light-emission end face.

### CROSS-REFERENCE TO RELATED APPLICATIONS

This application is a continuation application of PCT/JP2017/023062 claiming the benefit of priority of the Japanese Patent Application No. 2016-255547 filed on Dec. 28, 2016, the entire contents of which are incorporated herein by reference.

### TECHNICAL FIELD

The present invention relates to an optical device, a method for manufacturing an optical device, and a wavelength conversion method.

### BACKGROUND ART

Materials used for wavelength conversion optical devices utilizing a second-order nonlinear optical effect primarily include ferroelectric optical crystals such as a LiNbO₃ (LN) crystal, a KTiOPO₄ (KTP) crystal, a LiB₃O₅ (LBO) crystal, and a β-BaB₂O₄ (BBO) crystal. Optical devices using these crystals are used for wavelength conversion of various laser light sources and are expected to be used in a wide range of applications with the wavelength conversion as a primary application.

For example, in the fields of laser machining, optical tweezers, and the like, it is important to reduce a beam spot diameter by making a wavelength shorter for the purpose of enhancing fine processing and capturing power. In particular, second harmonic generation (SHG) is effective for reducing the beam spot diameter. Recently, it is possible to obtain a high condensing ability by using a vector beam in which a light beam is given a parameter of polarization distribution, as compared to a normal Gaussian beam. Therefore, a combination technique of such a vector beam and wavelength conversion is also expected.

### CITATION LIST

### Non-Patent Literature

Non-Patent Document 1: OYO BUTURI Vol. 83, No. 7 (2014) p. 560
Non-Patent Document 2: IEEE J. Quantum Electron., Vol. 28, Issue. 11 (1992) p. 263
Non-Patent Document 3: IEEE J. Quantum Electron., Vol. 30, Issue. 7 (1994) p. 1596
Non-Patent Document 4: Science Vol. 278 (1997) p. 843
Non-Patent Document 5: IEICE Transactions on Fundamentals of Electronics, Communications and Computer Sciences C-I J 77 (1994) p. 536
Non-Patent Document 6: KOGAKU Vol. 35, No. 12 (2006) p. 625
Non-Patent Document 7: Opt. Commun., 237, (2004) p. 89-95
Non-Patent Document 8: ECOC2008 PD Th3C5
Non-Patent Document 9: CERAMICS JAPAN Vol. 49, No. 7 (2014) p. 604
Non-Patent Document 10: Opt. Express, Vol. 19, No. 27 (2011) p. 26975

### SUMMARY OF INVENTION

### Technical Problem

As a result of examining the above-described conventional techniques, the inventors have found the following problems. That is, in the conventional wavelength conversion method using a wavelength conversion crystal, a condensing lens and a light diffusing lens are required. For example, wavelength conversion using a fiber laser light source causes problems such as an increase in coupling loss due to a lens, increases in complexity of alignment and size due to an increase in the number of components, and performance deterioration due to contamination on a lens surface. Therefore, compatibility between a wavelength converter and an optical fiber cannot be said to be good at all. Further, in wavelength conversion using other light sources, handleability and robustness are not high due to the fact that an increase in size is difficult because of single crystal and temperature control with high accuracy is required.

Note that the wavelength conversion method can be classified into two, quasi-phase matching (QPM) by periodically poling and angle phase matching. Of the two, the quasi-phase matching allows generation of various phase matching wavelengths by appropriately designing a periodically-poling pitch and wavelength conversion in all transparent regions of a material. Further, since the quasi-phase matching has no walk-off angle for the angle phase matching, beam quality is high, and an interaction length can be increased, so that the quasi-phase matching is suitable for increasing efficiency and inhibiting a coupling loss and is an effective method in machining, measurement, and the like.

In Non-Patent Document 1, it is reported that an optical cladding of an optical fiber is crystallized to exhibit second-order nonlinearity. Fresnoite (Ba₂TiSi₂O₈) is a titanosilicate mineral having a tetragonal structure and has spontaneous polarization due to a lack of poling symmetry. Further, crystals derived from fresnoite (Sr₂TiSi₂O₈, Ba₂TiGe₂O₈) also have spontaneous polarization. These fresnoite-type crystals exhibit nonlinear optical characteristics because of their spontaneous polarization. It is further reported that fresnoite phase is formed in BaO—TiO₂—GeO₂-based glass and SrO—TiO₂—SiO₂-based glass, so that BaO—TiO₂—GeO₂-based glass and SrO—TiO₂—SiO₂-based glass also exhibit nonlinear optical characteristics. A silica-based glass fiber is doped with these materials and is continuously crystallized with laser in a longitudinal direction of the fiber, thereby obtaining a radial polarization-ordered structure (see a polarization orientation at a position P2 shown in a table of FIG. 8). Note that a concern for crystallized glass is devitrification caused by crystallization. However, in Non-Patent Document 9, transparency is successfully achieved by reducing a difference in refractive index between a crystal phase and a residual glass phase that is a cause of devitrification.

However, as described above, in wavelength conversion using the optical fiber continuously crystallized in the longitudinal direction, the radial polarization-ordered structure defined by a polarization orientation is used. Therefore, wavelength conversion cannot be performed with general linear polarization. Further, propagation speeds of an incident wave (fundamental wave) and a wavelength-converted wave (hereinafter, referred to as an “SH wave”) are different from each other, which only causes light intensity of the wavelength-converted wave to periodically and repeatedly increase and decrease at intervals of a coherent length and makes it difficult to amplify the wavelength-converted wave.

Note that since a material of an optical fiber comprised of general silica-based glass (silica-based glass fiber) is amorphous, only the third-order nonlinear optical effect is utilized, and highly efficient wavelength conversion utilizing the second-order nonlinear optical effect is difficult. Further, in polarization induced by thermal poling reported in Non-Patent Document 10, wavelength conversion by quasi-phase matching is realized by periodical poling-erasure made by ultraviolet light (UV light) irradiation. However, in polarization in such an amorphous material, intensity of the polarization (nonlinear optical constant) changes due to UV light irradiation, which causes a decrease in wavelength conversion efficiency depending on an amount of irradiation and an irradiation time of illumination light and sun light, including UV light, and accordingly causes a problem in stability.

The present invention has been made to solve the above-described problems, and an object of the present invention is to provide an optical device that has high nonlinearity and UV light resistance and allows stable wavelength conversion, a method for manufacturing an optical device, and a wavelength conversion method.

### Solution to Problem

In order to solve the above-described problems, an optical device according to the present embodiment is comprised of glass containing SiO₂ and comprises: a light-incidence end face adapted to receive light; a light-emission end face disposed opposite to the light-incidence end face and adapted to output the light; and a repetitive structure provided between the light-incidence end face and the light-emission end face. The repetitive structure includes first sections and second sections alternately arranged from the light-incidence end face toward the light-emission end face, each of the first sections serving as a crystallized region, each of the second sections serving as a non-crystallized region. In particular, in each of the crystallized regions of the first sections, a radial polarization-ordered structure is formed.

### Advantageous Effects of Invention

According to the present embodiment, obtained is an optical device that allows high nonlinearity and UV light resistance by selective glass crystallization and allows stable wavelength conversion by realizing the radial polarization-ordered structure in the crystallized glass region.

### BRIEF DESCRIPTION OF DRAWINGS

FIG. 1 is a diagram showing an example of a cross-section structure of an optical fiber applicable to an optical device according to a first embodiment.

FIG. 2 is a table showing the cross-section structure and examples of a refractive index profile of the optical fiber applicable to the optical device according to the first embodiment.

FIG. 3 is a table showing examples of a doped region R (a region to be glass-crystallized) in the optical fiber applicable to the optical device according to the first embodiment.

FIG. 4 is a flowchart for describing an example of a method for manufacturing an optical device according to the first embodiment and a second embodiment.

FIG. 5 is a diagram for describing a method for intermittently applying laser light to the optical fiber.

FIG. 6 is a diagram showing an example of a configuration of the optical device according to the first embodiment.

FIG. 7 is a diagram showing an example of a configuration of a wavelength converter for executing a wavelength conversion method according to the first and second embodiments.

FIG. 8 is a table showing examples of polarization patterns and polarization states at positions P1 to P3 indicated in FIG. 7.

FIG. 9 is a developed view for describing of an example of a structure of an optical device according to the second embodiment.

FIG. 10 is a graph for describing an application range of a V number in the optical devices according to the first and second embodiments (part 1).

FIG. 11 is a graph for describing the application range of the V number in the optical devices according to the first and second embodiments (part 2).

### DESCRIPTION OF EMBODIMENTS

### Description of Embodiment of Present Invention

First, details of the embodiment of the present invention will be individually listed and described.

(1) One aspect of the optical device according to the present embodiment is comprised of glass containing SiO₂ and comprises: a light-incidence end face adapted to receive light; a light-emission end face disposed opposite to the light-incidence end face and adapted to output the light; and a repetitive structure provided between the light-incidence end face and the light-emission end face. The repetitive structure includes first sections and second sections alternately arranged along a center axis that extends from a center of the light-incidence end face toward a center of the light-emission end face, each of the first section serving as a crystallized region, each of the second sections serving as a non-crystallized region. In particular, in each of the crystallized regions of the first sections, a radial polarization-ordered structure is formed. Note that, each of the non-crystallized regions of the second sections is an air gap, a region filled with resin having a refractive index equivalent to a refractive index of the crystallized regions of the first sections, or a region filled with oil having a refractive index equivalent to the refractive index of the crystallized regions of the first sections.

(2) As one aspect of the present embodiment, the optical device may be an optical device of an optical fiber type comprised of glass containing SiO₂. In this aspect, the optical device comprises: a light-incidence end face; a light-emission end face; a central low refractive index region; a ring-shaped high refractive index region; a first cladding region; and a second cladding region. The central low refractive index region is located between the light-incidence end face and the light-emission end face and extends from the light-incidence end face toward the light-emission end face. The ring-shaped high refractive index region is located between the light-incidence end face and the light-emission end face, surrounds the central low refractive index region, and has a refractive index higher than that of the central low refractive index region. The first cladding region is located between the light-incidence end face and the light-emission end face, surrounds the ring-shaped high refractive index region, and has a refractive index lower than that of the ring-shaped high refractive index region. The second cladding region is located between the light-incidence end face and the light-emission end face, surrounds the first cladding region, and has a refractive index lower than that of the ring-shaped high refractive index region. As one aspect of the present embodiment, in at least a part of a glass region including the central low refractive index region, the ring-shaped high refractive index region, and the first cladding region, a repetitive structure that includes first sections, each serving as a crystallized regions, and second sections, each serving as a non-crystallized regions, alternately arranged in a direction from the light-incidence end face toward the light-emission end face, that is, in a longitudinal direction of the optical device of an optical fiber type is provided. In this aspect, the radial polarization-ordered structure is also formed in the crystallized regions of the first sections. Further, even in such an optical device of an optical fiber type, each of the non-crystallized regions of the second sections may be an air gap, a region filled with resin having a refractive index equivalent to a refractive index of the crystallized regions of the first sections, or a region filled with oil having a refractive index equivalent to the refractive index of the crystallized regions of the first sections.

(3) Note that, in the glass region, the part where the repetitive structure is provided is any one of part including the central low refractive index region or only part of the central low refractive index region, part including the ring-shaped high refractive index region or only part of the ring-shaped high refractive index region, part including the first cladding region or only part of the first cladding region, part extending from the central low refractive index region or part of the central low refractive index region to the ring-shaped high refractive index region or part of the ring-shaped high refractive index region, part extending from the ring-shaped high refractive index region or part of the ring-shaped high refractive index region to the first cladding region or part of the first cladding region, and part continuously extending from the central low refractive index region or part of the central low refractive index region to the first cladding region or part of the first cladding region through the ring-shaped high refractive index region. Further, the repetitive structure is defined by a repetition period, and one unit of the repetition period is defined by a length, in the direction from the light-incidence end face to the light-emission end face, of a region constituted by first and second sections adjacent to each other.

(4) As one aspect of the present embodiment, a ratio (r₁/r₂) of an inner radius r₁ of the ring-shaped high refractive index region to an outer radius r₂ of the ring-shaped high refractive index region preferably falls within a range of 0.6 to 0.8. Furthermore, as one aspect of the present embodiment, letting a wave number of light with a wavelength λ received through the light-incidence end face be k (=2πr/λ), a V number defined by a normalized frequency Vc (=k₀*(r₂²−r₁²)^{1/2}*(n₁²−n₀²)^{1/2}) of each mode with respect to the wave number k₀ of light with the wavelength λ propagating in vacuum preferably falls within a range of 2 to 5.

(5) As one aspect of the present embodiment, the crystallized regions of the first sections may contain a metal element as a glass-crystallization promoting dopant, and in this case, the metal element is preferably Ti. Further, as one aspect of the present embodiment, the crystallized regions of the first sections may contain a metalloid element as a glass-crystallization promoting dopant, and in this case, the metalloid element is preferably Ge. Furthermore, as one aspect of the present embodiment, the crystallized regions of the first sections may contain a monovalent or bivalent metal element as a devitrification inhibiting dopant, and in this case, the monovalent or bivalent metal element is preferably Sr or Ba.

(6) As one aspect of the present embodiment, the repetitive structure may have a single repetition period in the direction from the light-incidence end face to the light-emission end face. Further, as one aspect of the present embodiment, the repetition period of the repetitive structure in the direction from the light-incidence end face to the light-emission end face may be a chirp period (a period pattern in which a section length corresponding to one period repeatedly increases and decreases from the light-incidence end face toward the light-emission end face, a period that is a combination of a plurality of mutually different single periods, or a period based on a Fibonacci sequence or Barker sequence.

(7) As one aspect of the present embodiment, a length of each of the crystallized regions of the first sections in the direction from the light-incidence end face toward the light-emission end face preferably falls within a range of 1 μm to 1000 μm.

(8) One aspect of a method for manufacturing an optical device according to the present embodiment comprises: a preparation step of preparing a glass rod that includes crystallized regions of first sections and non-crystallized regions of second sections alternately formed along a center axis; a temperature control step, a laser irradiation step; and a region separation step. The glass rod prepared in the preparation step includes a light-incidence end face and a light-emission end face, extends along the center axis, and contains SiO₂. The glass rod further includes a doped region that constitutes at least a part of a cross section of the glass rod orthogonal to the center axis, and is formed over an entire length of the glass rod and doped with a glass-crystallization promoting dopant. In the temperature control step, a surface temperature of the glass rod is kept within a range of 100° C. to 1000° C. In the laser irradiation step, irradiation of laser light to the doped region forms, in the doped region, portions to be the crystallized regions of the first sections each having the polarization-ordered structure. In the separation section, the portions to be the crystallized regions of the first sections in the doped region are separated by forming portions to be the non-crystallized regions of the second sections at least in the doped region.

(9) As one aspect of the present embodiment, the glass rod in which the above-described repetitive structure is formed may be, for example, an optical fiber. In this case, the optical fiber prepared in the preparation step includes a light-incidence end face and a light-emission end face, is comprised of glass containing SiO₂, and includes a central low refractive index region, a ring-shaped high refractive index region, a first cladding region, and a second cladding region. The central low refractive index region is located between the light-incidence end face and the light-emission end face and extends in a longitudinal direction of the optical fiber (a direction from the light-incidence end face to the light-emission end face). The ring-shaped high refractive index region is located between the light-incidence end face and the light-emission end face, surrounds the central low refractive index region, and has a refractive index higher than that of the central low refractive index region. The first cladding region is located between the light-incidence end face and the light-emission end face, surrounds the ring-shaped high refractive index region, and has a refractive index lower than that the ring-shaped high refractive index region. The second cladding region is located between the light-incidence end face and the light-emission end face, surrounds the first cladding region, and has a refractive index lower than that of the ring-shaped high refractive index region. Further, in at least a part of a glass region including the central low refractive index region, the ring-shaped high refractive index region, and the first cladding region, a doped region doped with a glass-crystallization promoting dopant is provided continuously in the longitudinal direction. In the temperature control step, a surface temperature of the optical fiber is kept within a range of 100° C. to 800° C. Alternatively, the surface temperature of the optical fiber is kept within a range of 100° C. to 1000° C. The region separation step is included in the laser irradiation step and is a step of stopping irradiation of laser light to the doped region. In such a configuration, in the laser irradiation step, intermittent irradiation of laser light to the doped region in a direction from the light-incidence end face toward the light-emission end face forms, in the doped region, a repetitive structure including the crystallized regions of the first sections and the non-crystallized regions of the second sections alternately arranged along the center axis.

(10) Note that, as one aspect of the method for manufacturing an optical device according to the present embodiment, the laser light to be applied to the optical fiber preferably has a wavelength falling within a range of 100 nm to 1600 nm. In particular, as one aspect of the present embodiment, in the intermittent irradiation of laser light, a laser light source configured to emit pulse laser light is preferably used. In this case, a pulse width preferably falls within a range of 10 ps to 100 ms. Further, as one aspect of the present embodiment, in the intermittent irradiation of laser light, a laser light source configured to emit CW laser light is preferably used.

(11) As one aspect of the present embodiment, when an air gap, a region filled with resin having a refractive index equivalent to a refractive index of the crystallized regions of the first sections, or a region filled with oil having a refractive index equivalent to the refractive index of the crystallized regions of the first sections is formed in the glass rod as each of the non-crystallized regions of the second sections, the region separation step may be executed before or after the laser irradiation step. In this case, in the region separation step, grooves are periodically formed in the glass rod along the center axis to form the portions to be the non-crystallized regions of the second sections.

(12) Further, as one aspect of the present embodiment, in the region separation step, scraping part of the glass rod using a dicing saw, scraping the part of the glass rod using a wire saw, or removing the part of the glass rod by dry etching periodically forms the grooves in the glass rod.

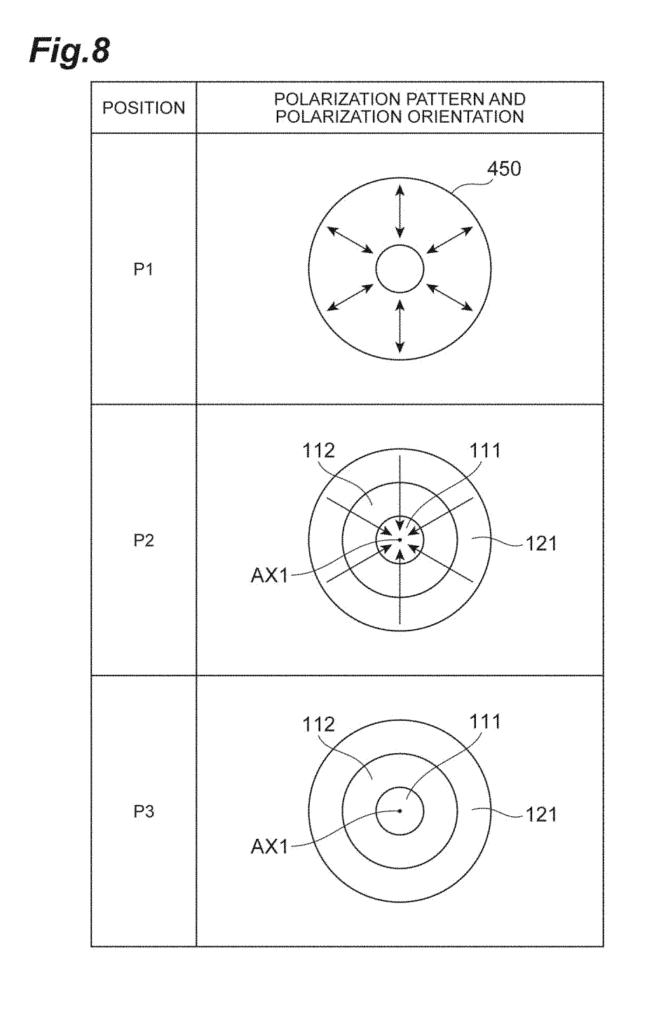

(13) One aspect of a wavelength conversion method according to the present embodiment causes a radially polarization vector beam to impinge on a light-incidence end face of an optical device (in a case of an optical device of an optical fiber type, one of fiber end faces) including such a structure as described above. In the crystallized regions of the first sections, as shown in the table of FIG. 8 (a polarization orientation at a position P2), a polarization orientation in a cross section of each of the first sections orthogonal to an optical axis AX1 is radial. Therefore, as shown in the table of FIG. 8 (a polarization pattern at a position P1), incident light is preferably a radially polarization vector beam whose polarization orientation is aligned with the polarization orientation of the radial polarization-ordered structure. In this case, since the polarization orientation of the incident light coincides with the polarization orientation of the first sections, a maximum nonlinear optical constant d₃₃ can be used. Further, crystallized regions in which the radial polarization-ordered structure is formed and non-crystallized regions are periodically formed in a longitudinal direction of the optical device (a direction from the light-incidence end face to the light-emission end face). The crystallized regions and the non-crystallized regions are made identical to a coherent length or an integral multiple of the coherence length, or have a non-periodic structure applied thereto. In a case of wavelength conversion using an optical device of an optical fiber type, it is possible to make a device length longer and employ various non-periodic structures. That is, since a phase matching bandwidth can be significantly made broader, wavelength conversion without temperature control is realized.

As described above, each of the aspects listed in “Description of embodiment of present invention” is applicable to all remaining aspects or all combinations of the remaining aspects.

### Details of Embodiment of Present Invention

Specific examples of an optical device, a method for manufacturing an optical device, and a wavelength conversion method according to the present invention will be described in detail below with reference to the attached drawings. It should be noted that the present invention is not limited to these examples, and is intended to be defined by the claims and to include all modifications within the scope of the claims and their equivalents. Further, in a description of the drawings, the same components are denoted by the same reference numerals, and a redundant description will be omitted.

### First Embodiment of Optical Device

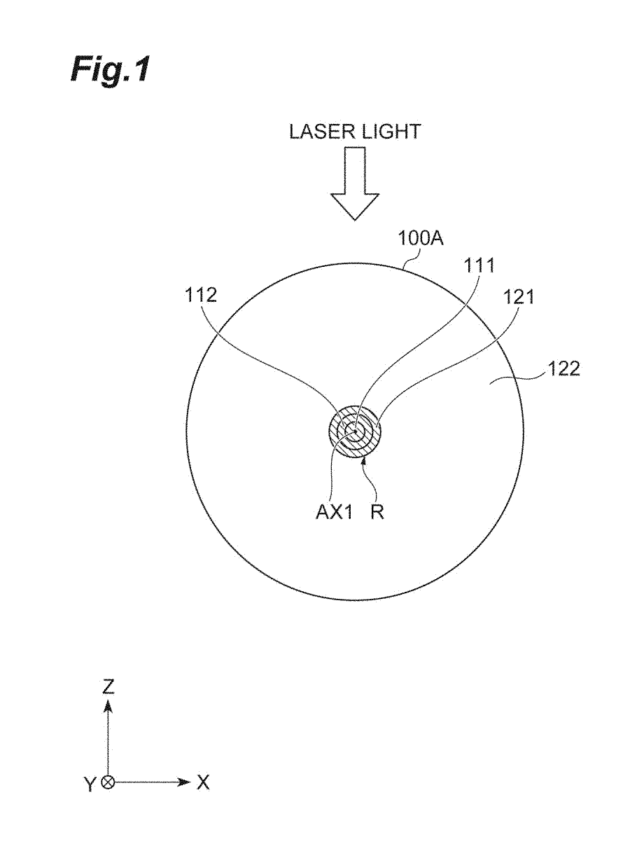

FIG. 1 is a diagram showing an example of a cross-section structure of an optical fiber applicable to an optical device according to the present embodiment. An optical fiber 100A of FIG. 1 is an optical fiber comprised of glass containing SiO₂ and having a core region extending along an optical axis AX1 and a cladding region surrounding the core region. The core region includes a central low refractive index region 111 and a ring-shaped high refractive index region 112, and the cladding region includes a first cladding region 121 and a second cladding region 122. Further, the central low refractive index region 111 extends along the optical axis AX1. The ring-shaped high refractive index region 112 surrounds the central low refractive index region 111 and has a refractive index higher than that of the central low refractive index region 111. The first cladding region 121 surrounds the ring-shaped high refractive index region 112 and has a refractive index lower than that of the ring-shaped high refractive index region 112. The second cladding region 122 surrounds the first cladding region 121 and has a refractive index lower than that of the ring-shaped high refractive index region 112. One end face of the optical fiber serves as a light-incidence end face, and the other end face serves as a light-emission end face. Further, in at least a part a glass region including the central low refractive index region 111, the ring-shaped high refractive index region 112, and the first cladding region 121, a doped region R (a hatched region in FIG. 1) doped with a glass-crystallization promoting dopant is continuously provided in the longitudinal direction.

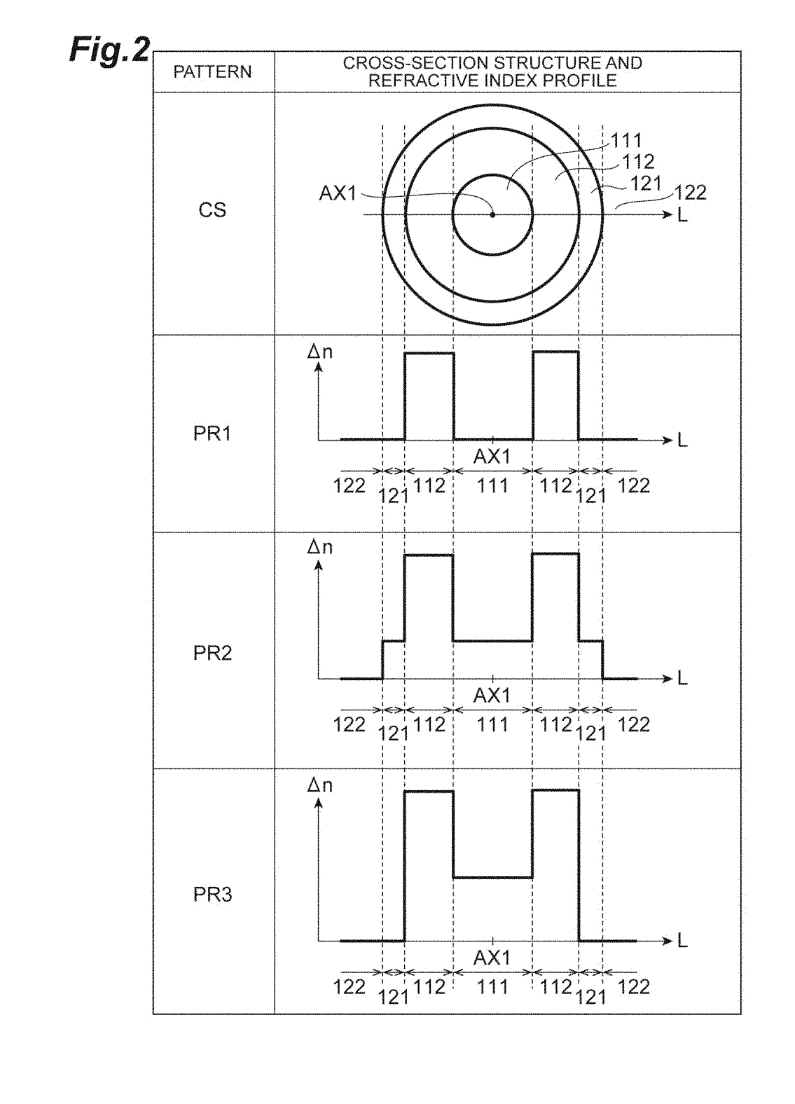

Here, various shapes are applicable to the refractive index profile of the optical fiber 100A, as shown in a table of FIG. 2. Specifically, in the table of FIG. 2, a pattern CS shows a structure of a cross section (a plane orthogonal to the optical axis AX1) of the optical fiber 100A. Further, patterns PR1 to PR3 are examples of various refractive index profiles of the optical fiber 100A, showing, in the cross section of the pattern CS, a relative refractive index difference Δn of each portion on a line L passing through the optical axis AX1 (a relative refractive index difference of each portion based on the second cladding region 122). In a refractive index profile of the pattern PR1, the ring-shaped high refractive index region 112 is set higher in refractive index than the central low refractive index region 111, the first cladding region 121, and the second cladding region 122. Note that the pattern PR1 is an example of a refractive index profile in which the central low refractive index region 111, the first cladding region 121, and the second cladding region 122 are identical to each other in refractive index, but the central low refractive index region 111, the first cladding region 121, and the second cladding region 122 need not be necessarily identical to each other in refractive index. In a refractive index profile of the pattern PR2, the central low refractive index region 111 is set lower in refractive index than the ring-shaped high refractive index region 112 but higher in refractive index than the second cladding region 122. Further, the first cladding region 121 is also set lower in refractive index than the ring-shaped high refractive index region 112 but higher in refractive index than the second cladding region 122. Note that the pattern PR2 is an example of a refractive index profile in which the central low refractive index region 111 and the first cladding region 121 are identical to each other in refractive index, but the central low refractive index region 111 and the first cladding region 121 need not be necessarily identical to each other in refractive index. In a refractive index profile of the pattern PR3, the ring-shaped high refractive index region 112 is set higher in refractive index than the central low refractive index region 111, the first cladding region 121, and the second cladding region 122, and the central low refractive index region 111 is set higher in refractive index than the first cladding region 121 and the second cladding region 122. Note that the pattern PR3 is an example of a refractive index profile in which the first cladding region 121 and the second cladding region 122 are identical to each other in refractive index, but the first cladding region 121 and the second cladding region 122 need not be necessarily identical to each other in refractive index.

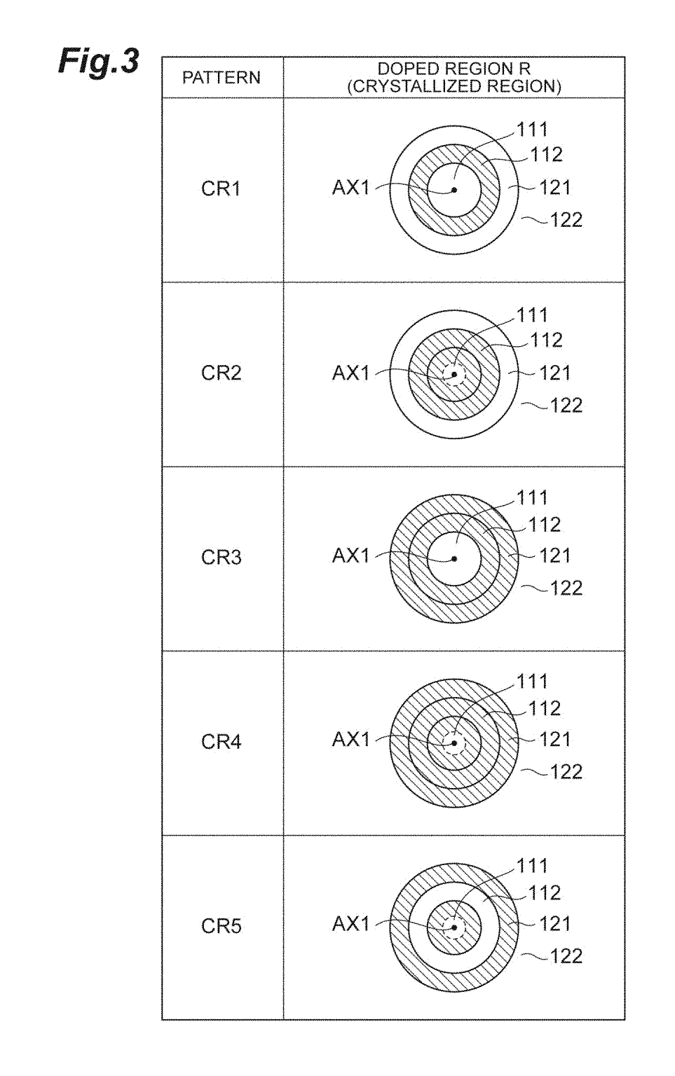

Similarly, various doped patterns are applicable to the doped region R of the optical fiber 100A, and, for example, patterns CR1 to CR5 as shown in a table of FIG. 3 are applicable to the doped region R. Specifically, in the table of FIG. 3, a doped region R of the pattern CR1 includes only the ring-shaped high refractive index region 112 as indicated by a hatched region. A doped region R of the pattern CR2 includes part of the central low refractive index region 111 (outer portion of the central low refractive index region 111) and all of the ring-shaped high refractive index region 112 as indicated by a hatched region. A doped region R of the pattern CR3 includes all of the ring-shaped high refractive index region 112 and all of the first cladding region 121 as indicated by a hatched region. A doped region R of the pattern CR4 includes part of the central low refractive index region 111 (the outer portion of the central low refractive index region 111), all of the ring-shaped high refractive index region 112, and all of the first cladding region 121 as indicated by a hatched region. Further, a doped region R of the pattern CR5 includes regions between which the ring-shaped high refractive index region 112 is sandwiched, that is part of the central low refractive index region 111 (the outer portion of the central low refractive index region 111) and all of the first cladding region 121 as indicated by a hatched region.

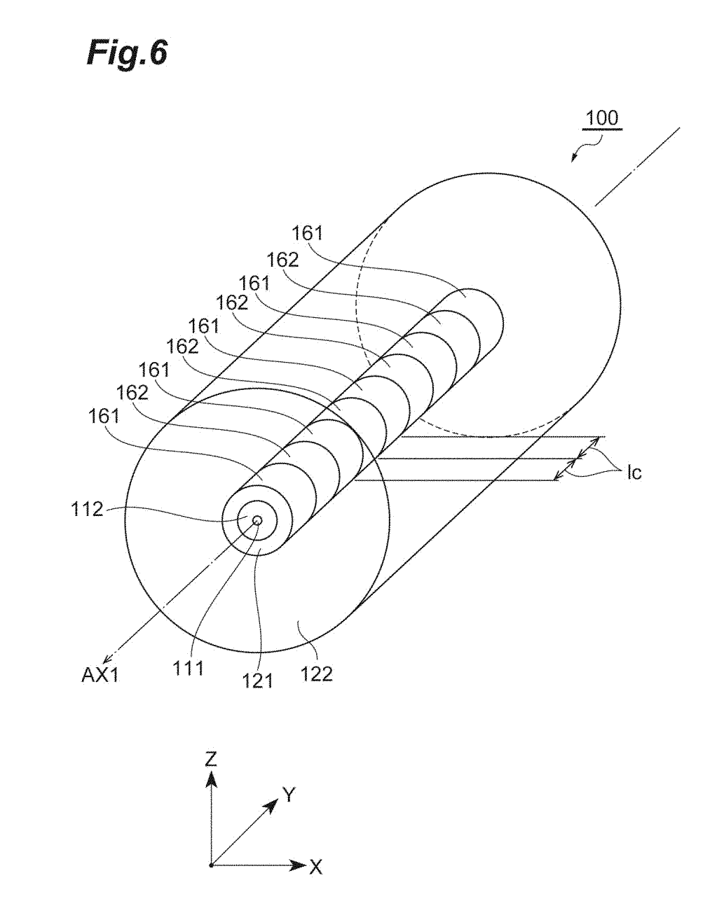

The optical device according to the present embodiment includes, in the optical fiber 100A including the above-described structure, a repetitive structure including crystallized regions (first sections) in which a radial polarization-ordered structure is formed and non-crystallized regions (second sections) in which no polarization is formed alternately arranged in the longitudinal direction (a direction coincident with the optical axis AX1) of the optical fiber 100A (see FIG. 6). Note that the glass crystallization and the formation of the radial polarization-ordered structure in the optical fiber 100A are realized by intermittent irradiation of laser light.

Note that, in the optical device according to the present embodiment, since the radial polarization-ordered structure is formed in the crystallized regions of the first sections, a second-order nonlinear optical constant is maintained unless the crystal structure is broken. That is, the optical device according to the present embodiment is resistant to disturbances such as irradiation of UV light and accordingly enables stable wavelength conversion. Further, crystallization of the inside of the optical device according to the present embodiment makes it possible to increase the nonlinear optical constant by about 1 to 2 digits (makes it possible to significantly increase conversion efficiency) as compared to thermal poling to a Ge-doped core region.

On the other hand, since no polarization-ordered structure is formed in the non-crystallized regions of the second sections, the second-order nonlinear optical constant (d constant) becomes zero. Efficiency of wavelength conversion by second-order nonlinear optical effect is proportional to the square of the d constant. Note that the d constant depends on a physical property value of a material, and the larger the d constant is, the more the conversion efficiency increases. When the d constant is zero, wavelength conversion cannot be performed.

Doping at least a part (doped region R) of the glass region including the central low refractive index region 111, the ring-shaped high refractive index region 112, and the first cladding region 121 in the optical fiber 100A of FIG. 1 with a glass-crystallization promoting dopant allows the d constant to be developed (see FIGS. 1 and 3).

Specifically, at least a part (doped region R) of the glass region including the central low refractive index region 111, the ring-shaped high refractive index region 112, and the first cladding region 121 of optical fiber 100A is doped with a raw material such as fresnoite-type crystal, BaO—TiO₂—GeO₂—SiO₂-based glass, or SrO—TiO₂—SiO₂-based glass as a dopant. Laser-assisted glass crystallization is performed on the doped region R. That is, a region to be crystallized is doped with a rare-earth, a transition metal element, or the like and heated by absorption of laser light, thereby crystallizing the region to which the laser light has been applied. In the crystallized region thus obtained, the radial polarization-ordered structure is formed in which polarization-orientation is directed from an outer periphery to a center of the optical fiber 100A. In order to inhibit devitrification caused by the crystallization, it is necessary to cause respective refractive indices of a crystal phase and a residual glass phase to match each other, and the devitrification can be inhibited by using 35SrO-20TiO₂-45SiO₂-based glass or the like (see Non-Patent Document 1 and Non-Patent Document 9). The nonlinear optical constant in the doped region thus crystallized is resistant to disturbances (UV light) and is accordingly increased in stability.

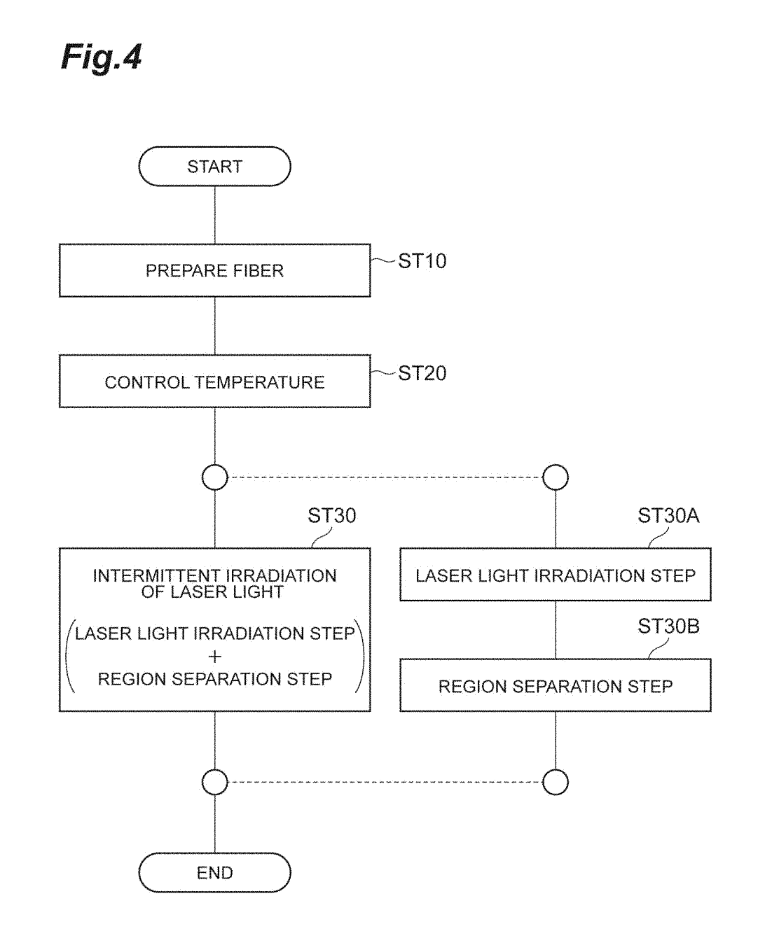

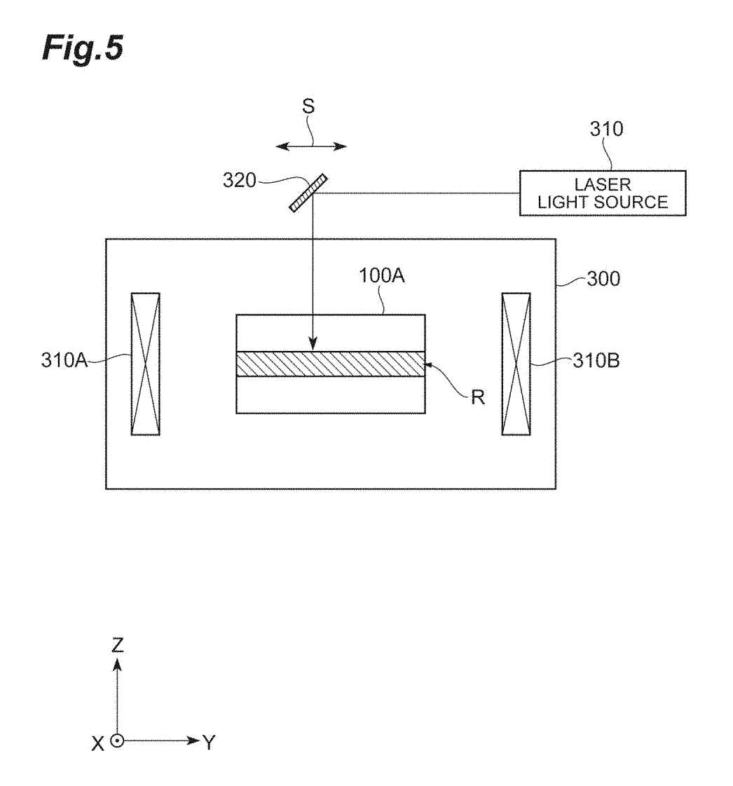

FIG. 4 is a flowchart for describing an example of a method for manufacturing an optical device according to the first embodiment and a second embodiment. Further, FIG. 5 is a diagram for describing a method for applying laser light to a glass rod or an optical fiber. Manufacturing an optical device in accordance with the flowchart of FIG. 4 results in an optical device 100 (the optical device according to the first embodiment) of an optical fiber type having a structure shown in FIG. 6.

First, the optical fiber 100A having the cross-section structure shown in FIG. 1 is prepared (step ST10: preparation step). Subsequently, a surface temperature of the optical fiber 100A is controlled so as to fall within a range of 100° C. to 800° C., or a range of 100° C. to 1000° C. (step ST20: temperature control step).

The temperature control in step ST20 and the subsequent manufacturing steps may be performed in a chamber 300 shown in FIG. 5. Note that, in the chamber 300, provided are heaters 310A, 310B for maintaining the temperature of the optical fiber 100A constant.

In a state where the surface temperature is under control, intermittent irradiation of laser light (step ST30) is performed on the optical fiber 100A. That is, the intermittent irradiation of laser light is realized by a combination of a laser irradiation step of irradiating laser light to the doped region R and a region separation step of stopping the irradiation of laser light (the region separation step is part of the laser irradiation step). Specifically, in step ST30, as shown in FIG. 5, the laser light from a laser light source 310 is intermittently irradiated to the doped region R via a reflection mirror 320 movable in the longitudinal direction (the direction indicated by an arrow S) of the optical fiber 100A (whose surface temperature is kept within the range of 100° C. to 800° C., or the range of 100° C. to 1000° C. by the heaters 310A, 310B). This forms, in the doped region R of the optical fiber 100A, a repetitive structure including the crystallized regions (first sections) and the non-crystallized regions (second sections) alternately arranged in the longitudinal direction is formed. Note that polarization-orientation remaining in the non-crystallized regions of the second sections is eliminated by poling-erasure in which UV light (whose light amount is less than an amount of UV light irradiation that can erase polarization in the crystallized regions) is applied to the doped region R.

A wavelength of the laser light is preferably within a range of 100 nm to 1600 nm. As the laser light source 310, either a pulse light source or a CW light source may be used. The use of the pulse light source makes it possible to inhibit unnecessary heat generation and accurately write the glass region to be crystallized. A pulse width is preferably within a range of 10 ps to 100 ms. The use of the CW light source makes it possible to increase accuracy in writing with diffracted light generated by a phase mask, for example. Note that the use of a high-power laser light source makes it possible to enlarge an area to which a beam required for crystallization is applied, increase a range of diffracted light generated by an optical phase mask, and accordingly increase productivity as compared to one-stroke writing.

FIG. 6 is a diagram showing a configuration of the optical device 100 according to the first embodiment, the optical device 100 beings manufactured in accordance with the above-described flowchart of FIG. 4. The optical device 100 is an optical device of a fiber type including a light-incidence end face and a light-emission end face opposite to the light-incidence end face and comprised of glass containing SiO₂. A refractive index profile in a cross section orthogonal to the optical axis AX1 is the same as the refractive index profile of the optical fiber 100A described in FIGS. 1 and 2. The optical device 100 includes, in at least a part of the glass region including the central low refractive index region 111, the ring-shaped high refractive index region 112, and the first cladding region 121 (in the example shown in FIG. 6, all of the glass region corresponds to the doped region R), a repetitive structure including crystallized regions 161 (first sections) whose cross sections are entirely or partially polarization-oriented in one direction and non-crystallized regions 162 (second sections) alternately arranged in the longitudinal direction (a direction coincident with the optical axis AX1 in FIG. 6). A repetition period of the repetitive structure is within a range of 1 μm to 1000 μm. In order to realize highly efficient wavelength conversion, respective longitudinal lengths of the crystallized regions 161 and the non-crystallized regions 162 are preferably equal to a coherence length lc. Alternatively, when there is a manufacturing constraint, the longitudinal lengths are preferably equal to an integral multiple of the coherence length. Note that an increase in band of a phase matching condition may be required. In such a case, for the repetition period of the repetitive structure, an aperiodic periodically-poled structure (chirp (refer Non-Patent Document 2), a structure in which, with a periodic Λ1 region, a periodic Λ2 region, and a periodic Λ3 region, and a periodic region defined as one segment, the segments are arranged at certain intervals (see Non-Patent Document 3), a period based on a Fibonacci sequence (see Non-Patent Document 4), or a period based on a Barker sequence (see Non-Patent Document 5)) may be employed.

Note that, in the optical device 100 thus obtained, while a radial polarization-ordered structure is formed in the crystallized regions 161 (see a polarization orientation at a position P2 in the table of FIG. 8), the non-crystallized regions 162 are amorphous and accordingly has no polarization-ordered structure (the nonlinear optical constant is zero). When an unnecessary nonlinear optical constant remain in the non-crystallized regions 162, it is possible to forcibly cause the non-crystallized regions 162 to undergo the poling-erasure by irradiation of UV light. However, in order to allow only the non-crystallized regions 162 to undergo the poling-erasure by irradiation of UV light, it is required that a light amount be less than an amount of UV light irradiation (UVₜₕ) that damages the crystallized regions 161. At this time, no problem arises even under no temperature control, and as long as the amount of UV light irradiation is less than UVₜₕ, only polarization of the non-crystallized regions can be erased, and the quasi-phase matching (QPM) is achieved even after the UV light irradiation.

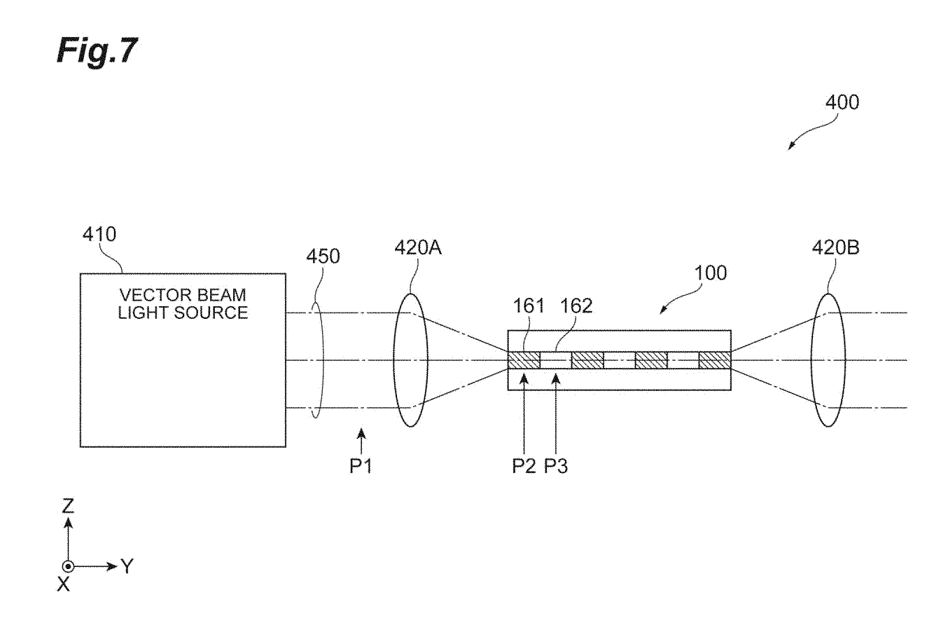

FIG. 7 is a diagram showing an example of a configuration of a wavelength converter for executing a wavelength conversion method according to the present embodiment. FIG. 8 is a table showing examples of polarization patterns and polarization states at positions P1 to P3 indicated in FIG. 7.

A wavelength converter 400 shown in FIG. 7 includes a vector beam light source 410 that emits a radially polarization vector beam, a pair of collimating lenses 420A, 420B, and the optical device 100 of an optical fiber type disposed between the pair of collimating lenses 420A, 420B. As shown in FIG. 6, in the doped region R including the central low refractive index region 111, the ring-shaped high refractive index region 112, and the first cladding region 121, the optical device 100 includes the repetitive structure including the crystallized regions 161 serving as the first sections and the non-crystallized regions 162 serving as the second sections alternately arranged in the longitudinal direction of the optical device 100. A radially polarization vector beam 450 emitted from the vector beam light source 410 is condensed by the collimating lens 420A and taken into the optical device 100 through the light-incidence end face of the optical device 100. On the other hand, wavelength-converted light propagated in the optical device 100 is emitted from the light-emission end face of the optical device 100 toward the collimating lens 420B and then collimated by the collimating lens 420B.

Here, a polarization pattern of the radially polarization vector beam 450 at the position P1 in FIG. 7 has radial polarization as shown in the table of FIG. 8. Further, the position P2 indicates an inside of one of the crystallized regions 161 including the central low refractive index region 111, the ring-shaped high refractive index region 112, and the first cladding region 121, and, as shown in the table of FIG. 8, the crystallized region 161 includes a radial polarization-ordered structure. Further, the position P3 indicates an inside of one of the non-crystallized regions 162 including the central low refractive index region 111, the ring-shaped high refractive index region 112, and the first cladding region 121, and, as shown in the table of FIG. 8, no polarization-ordered structure is formed in the non-crystallized region 162.

As described above, the radially polarization vector beam 450 impinges, through the light-incidence end face of the optical device 100, on the doped region R of the optical device 100 in which the crystallized regions 161 where the radial polarization-ordered structure is formed and the non-crystallized regions 162 are alternately arranged to cause the polarization orientation of the crystallized regions 161 to coincide with the polarization. This makes it possible to use a maximum value d₃₃ as the nonlinear optical constant. Further, setting a distance between the crystallized regions 161 and a distance between the non-crystallized regions 162 to the coherence length or applying a non-periodic structure enables highly efficient wavelength conversion. In particular, in a case of wavelength conversion using optical device 100 of an optical fiber type as the optical device of FIG. 7, it is possible to make a device length longer and employ various non-periodic structures. That is, since a phase matching bandwidth can be significantly made broader, wavelength conversion without temperature control is realized.

Note that a solid-state laser, a fiber laser, a gas laser, or the like is applicable to the vector beam light source 410 of FIG. 7. In particular, the solid-state laser is effective because the solid-state laser can generate an axially symmetric polarization vector beam directly in a laser resonator (Non-Patent Document 6). The fiber laser light source is effective because a vector beam is generated by utilizing a waveguide mode LP₁₁ and appropriately selecting a core diameter of the optical fiber (a diameter of the region including the central low refractive index region 111 and the ring-shaped high refractive index region 112), an incident beam diameter, polarization, and a spatial distribution of an electric field (Non-Patent Document 7). There is another method for obtaining a vector beam by superimposition of TEM₀₁- and TEM₁₀-mode harmonic beams, polarization control using optical activity of a nematic liquid crystal, or the like.

As described above, the optical device 100 that executes wavelength conversion is obtained by doping a silica-based optical fiber with a raw material such as fresnoite-type crystal, BaO—TiO₂—GeO₂—SiO₂-based glass, or SrO—TiO₂—SiO₂-based glass and performing laser-assisted crystallization on the doped region. A technique for inhibiting the devitrification caused by crystallization can also be implemented in accordance with the above-described technique. That is, a region to be crystallized is doped with a rare-earth, a transition metal, or the like and heated by absorption of laser light, thereby crystallizing the region to which the laser light has been applied. In order to inhibit the devitrification caused by glass crystallization, it is necessary to cause respective refractive indices of the crystal phase and the residual glass phase to match each other, and the devitrification can be inhibited by using 35SrO-20TiO₂-45SiO₂-based glass or the like (see Non-Patent Document 1, Non-Patent Document 8, and Non-Patent Document 9). Further, crystallization of the glass region in which the polarization-ordered structure is formed makes the nonlinear optical constant resistant to disturbances (UV light) and more stable.

Furthermore, consider wavelength conversion of SHG A material has refractive index dispersion where a refractive index varies depending on a wavelength. A fundamental wave and an SH wave (wavelength-converted wave) are different from each other in propagation speed. For this reason, wavelength conversion cannot be realized even with a nonlinear material. In order to realize wavelength conversion, it is necessary to align phases of the fundamental wave and the SH wave, and the phase alignment can be achieved by the above-described QPM. In this method, when a propagation speed difference Δk between the fundamental wave and the SH wave deviates by π (this distance is the coherence length: lc=π/Δk), a spontaneous polarization Ps is set to zero, thereby satisfying the phase matching. That is, when signs, +1 (crystallized region) and 0 (non-crystallized region), of the d constant are alternately arranged at intervals of lc, the SH waves are constructively added together and accordingly SH light is increased, which in turn enables highly efficient wavelength conversion.

### Second Embodiment of Optical Device

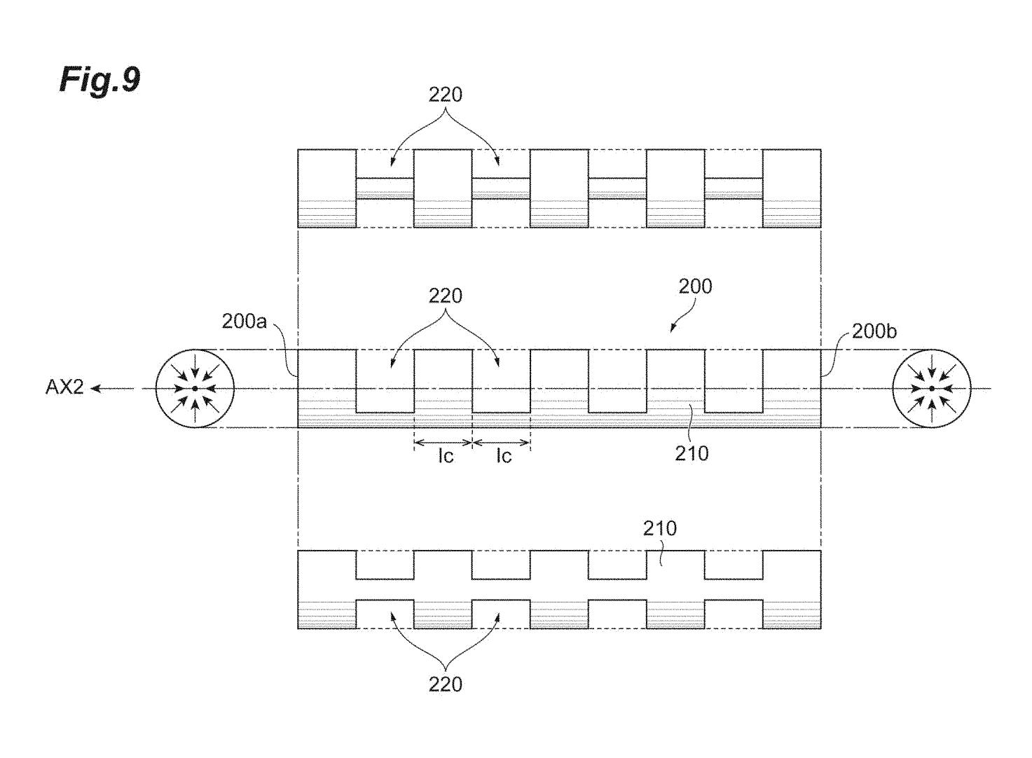

In the first embodiment described above, a description has been given of an example where the crystallized regions 161 are formed in the glass region including an optical waveguide structure such as the optical fiber 100A. However, as long as the polarization of the incident light and the direction of the polarization-orientation in the crystallized glass coincide with each in the radial direction, it is not limited to such a glass region including a waveguide structure. Hereinafter, a description will be given of an optical device according to a second embodiment with reference to FIGS. 9 to 11. Note that an optical device 200 according to the second embodiment is also applicable to the wavelength converter shown in FIG. 7, in place of the optical device 100 according to the first embodiment.

FIG. 9 is a developed view showing an example of a structure of the optical device 200 according to the second embodiment. As shown in FIG. 9, the optical device 200 according to the second embodiment includes a light-incidence end face 200a, a light-emission end face 200b, and crystallized regions 210 (first sections) and non-crystallized regions 220 (second sections) alternately arranged along a center axis AX2 extending from a center of the light-incidence end face 200a to a center of the light-emission end face 200b. A glass rod in which the crystallized regions 210 of the first sections and the non-crystallized regions 220 of the second sections are formed is entirely doped with a glass-crystallization promoting dopant (all of the glass rod corresponds to the doped region R shown in FIG. 1). Note that, in the second embodiment, each of the non-crystallized regions 220 of the second sections is an air gap, a region filled with resin having a refractive index equivalent to a refractive index of the crystallized regions 210 of the first sections, or a region filled with oil having a refractive index equivalent to the refractive index of the crystallized regions 210 of the first sections.

In the process of crystal growth, crystal nuclei are first generated in an interface between a region to be crystallized and a region not to be crystallized of different materials or a boundary with air, and crystal grows from the crystal nuclei. For example, in the optical device 100 of an optical fiber type according to the first embodiment, among the portions that have undergone the crystallization process by laser irradiation (heat application), in a glass region on a core side relative to the boundary between the core and the cladding, the crystal nuclei are generated. Orientation of the crystal nucleus is approximately perpendicular to a tangent to a cylindrical shape of the core, and the crystal grows toward a center of the core. As a result, as shown in the light-incidence end face 200a and the light-emission end face 200b in FIG. 9, a radial polarization-ordered structure is formed.

A method for manufacturing the optical device 200 according to the second embodiment shown in FIG. 9 is different from the method according to the first embodiment in that the laser irradiation step and the region separation step are performed separately. That is, in accordance with the flowchart of FIG. 4, a glass rod having such a structure as described above is prepared (step ST10: preparation step). Note that the glass rod to be prepared may have any refractive index profile of the patterns PR1 to PR3 shown in FIG. 2. A diameter of the glass rod is within a range of 0.5 mm to several tens of mm at which the incident laser light becomes collimated light, and the significant size is several mm. Further, a rod length of the glass rod (a length along the center axis AX2 from the light-incidence end face 200a to the light-emission end face 200b) is within a range of 1 mm to several thousands of mm.

Subsequently, a surface temperature of the glass rod is controlled so as to fall within a range of 100° C. to 1000° C. (step ST20: temperature control step). The temperature control in step ST20 and the subsequent manufacturing steps may be performed in the chamber 300 shown in FIG. 5. Note that, in the chamber 300, provided are the heaters 310A, 310B for maintaining the temperature of the glass rod constant.

In a state where the surface temperature in under control as described above, the laser light is applied to the glass rod continuously along the longitudinal direction of the glass rod (step ST30A: laser irradiation step). Specifically, in step ST30A, as shown in FIG. 5, the laser light from the laser light source 310 is applied to the doped region R via the reflection mirror 320 movable in the longitudinal direction (the direction indicated by the arrow S) of the glass rod (whose surface temperature is kept within the range of 100° C. to 1000° C. by the heaters 310A, 310B). This allows all of the glass rod to be a crystallized region (first section).

Subsequent to the laser irradiation step in step ST30A, machining the glass rod along the center axis AX2 to remove part of the glass rod at intervals forms gaps (that may be filled with resin or oil) each corresponding to the non-crystallized region (second section) (step ST30B: region separation step). Specifically, portions to be the non-crystallized regions 220 of the second sections having a thickness equivalent to the coherent length, an odd multiple of the coherent length, or a thickness of a higher-order, such as the second-order or the third-order, phase matching condition are removed from the glass rod over the entire length of the glass rod. Alternatively, portions having a thickness of a non-periodic structure that allows an increase in phase matching band are removed from the glass rod. A length of a portion removed from the glass rod (a distance between adjacent crystallized regions 210) corresponds to the coherent length, the odd multiple of the coherent length, or a distance of the higher-order, such as the second-order or the third-order, phase matching condition. Alternatively, the length corresponds to a distance of the non-periodic structure that allows an increase in phase matching band. A region between adjacent crystallized regions 210 may be an air gap, or may be a region filled with resin, oil, or the like having a refractive index equivalent to the refractive index of the crystallized regions 210. This forms, in the glass rod, a repetitive structure including the crystallized regions 210 of the first sections and the non-crystallized regions 220 of the second sections having a section length Ic and alternately arranged along the center axis AX2.

The groove formation at portions to be the non-crystallized regions 220 of the second sections may be made by scraping part of the glass rod including a radial polarization-ordered structure using a dicing saw or a wire saw. Alternatively, the groove formation may be made by removing part of the glass rod by dry etching.

Next, a description will be given of a fiber structure for efficiently generating the fundamental wave and the SH wave. Note that an example of the fiber structure to be described below is a fiber structure having the pattern PR1 (ring core) of FIG. 2.

Requirements for the fiber structure for converting a wavelength of a radially polarized beam are as follows:

(1) the fundamental wave and the SH wave are capable of TM₀₁ mode propagation;

(2) with respect to the SH wave, higher-order TM₀₂ mode does not occur, or the TM₀₂ mode occurs, but is small;

(3) to increase the wavelength conversion efficiency, an overlap (overlap integral) of light intensity distributions of the fundamental wave and the SH wave is large; and

(4) to inhibit mode conversion, a propagation constant difference in each of TM₀₁ and HE₂₁ modes is large.

Note that a propagation constant k_{TM01} of TM₀₁ mode of each of the fundamental wave and the SH wave is close to a propagation constant k_{HE21} of HE₂₁ (even or odd) mode, and accordingly mode conversion between TM₀₁ mode and HE₂₁ mode is easily made. Therefore, as in the above requirement (4), it is preferable that the propagation constant difference in each of TM₀₁ mode and HE₂₁ mode be large. As for Δk=k_{TM01}−k_{HE21}, 0.00005 or more is effective.

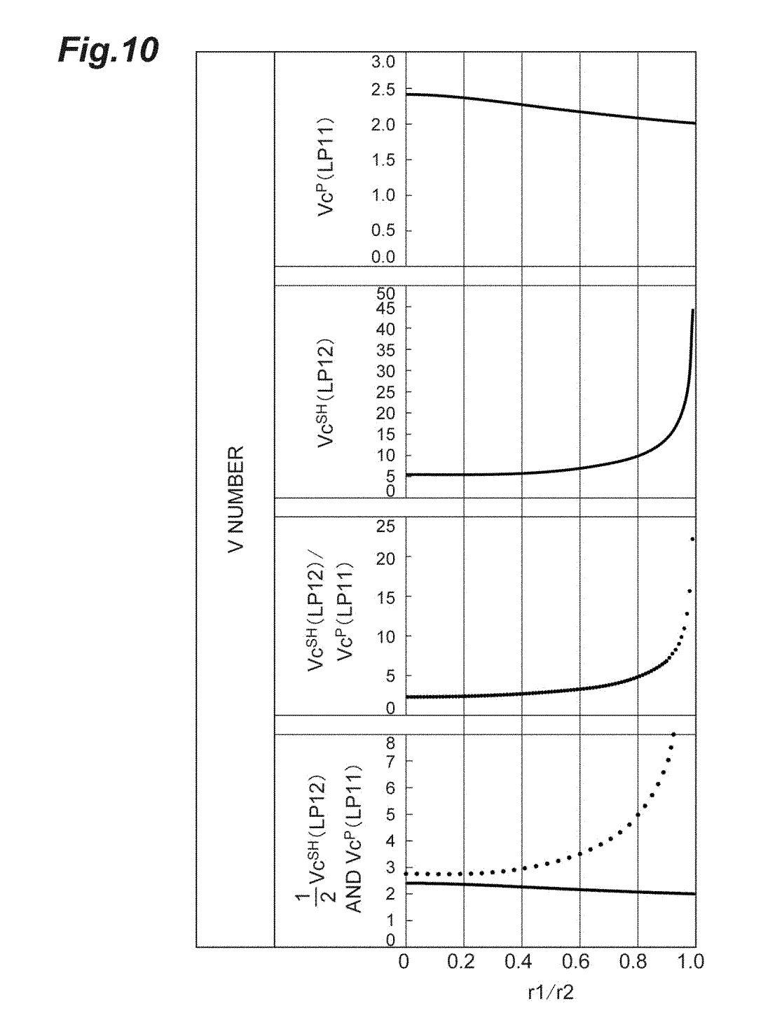

First, the above requirement (1) will be described. Here, TM₀₁ mode and HE₂₁ mode each correspond to LP₁₁ mode in scalar wave analysis. Therefore, a normalized frequency Vc^{P} of LP₁₁ mode of the fundamental wave and the SH wave was calculated. The calculation result is the top graph in FIG. 10 (hereinafter, referred to as the first graph). Note that a V number on the ordinate axis of each graph in FIG. 10 is determined based on a normalized frequency of each mode of incident light having a wavelength λ. In the first graph, the abscissa axis represents a ratio (r₁/r₂) of an inner radius r₁ to an outer radius r₂ of a ring portion corresponding to the ring-shaped high refractive index region 112 in FIG. 2, and the ordinate axis represents the V number determined based on the normalized frequency Vc^{P} (LP₁₁) of LP₁₁ mode of the fundamental wave and the SH wave. Note that when a wave number of incident light having the wavelength λ is represented by k (=2π/λ), the normalized frequency Vc of each mode is given by the following equation:

Vc=k₀*(r₂²−r₁²)^{1/2}*(n₁²−n₀²)^{1/2}.

Here, k₀ in the equation represents the wave number of the incident light in vacuum. Further, n₁ represents the refractive index of the ring core, and n₀ represents the refractive index of the cladding. When r₂ is constant, the normalized frequency Vc falls to the right as the width of the ring core decreases. This makes it necessary to, in order to propagate LP₁₁ mode, raise Δ(%) (=(n₁²−n₀²)/2n₁²) of the ring portion (corresponding to the ring-shaped high refractive index region 112) with respect to the cladding (corresponding to the second cladding region 122).

Next, a normalized frequency Vc^{SH} of LP₁₂ mode that is a higher-order mode of the SH wave was calculated. The calculation result is the second graph from the top in FIG. 10 (hereinafter, referred to as the “second graph”). In the second graph, the abscissa axis represents a ratio (r₁/r₂) of the inner radius r₁ to the outer radius r₂ of the ring portion, and the ordinate axis represents the V number determined based on the normalized frequency Vc^{SH} (LP₁₂) of LP₁₂ mode of the SH wave. As can be seen from the second graph, the normalized frequency increases as the width of the ring portion decreases (r₁/r₂ increases), so that it is necessary to make Δ(%) lower in order to prevent LP₁₂ mode of the SH wave from being generated.

The third graph from the top in FIG. 10 (hereinafter, referred to as the “third graph”) shows a calculation result of a ratio Vc^{SH}(LP₁₂)/Vc^{P}(LP₁₁) of the V number to the ratio r₁/r₂. Note that the numerator of the ratio Vc^{SH}(LP₁₂)/Vc^{P}(LP₁₁) on the ordinate axis represents the normalized frequency of LP₁₂ mode of the SH wave, and the denominator represents the normalized frequency of LP₁₁ mode of the fundamental wave and the SH wave. As described above, since Vc^{SH}(LP₁₂) is the normalized frequency of the SH wave (for example, when the SH wave has a wavelength of 532 nm, k_{0.532}=2πn_{0.532}/0.532, and when the fundamental wave has a wavelength of 1064 nm, k_{1.064}=2π_{1.064}/1.064, where n_{0.532}≈n_{1.064}), as long as the ratio Vc^{SH}(LP₁₂)/Vc^{P}(LPᵢᵢ) is equal to or more than two, the above requirements (1) and (2) will be satisfied. In fact, the third graph also shows that the ratio is equal to or more than two over the abscissa axis representing r₁/r₂, and it can be seen that the requirements (1) and (2) are satisfied.

For a more detailed review, the bottom graph in FIG. 10 (hereinafter, referred to as the “fourth graph”) shows a range where LP₁₁ mode of the fundamental wave is present as the V number with respect to the ratio r₁/r₂ (abscissa axis), but LP₁₂ mode is not present. A dotted line in the fourth graph represents a half of the V number (=Vc^{SH}(LP₁₂)) of the second graph, (Vc^{SH}(LP₁₂)/2≈Vc^{P}(LP₁₂)). A solid line in the fourth graph represents the V number (=Vc^{P}(LP₁₁)) of the first graph. In the fourth graph, a region between the dotted line graph and the solid line gives important knowledge from the viewpoint of the propagation mode. This fourth graph becomes a basis of fiber design for highly efficient wavelength conversion of a radially polarized beam. However, when the above requirements (3) and (4) are taken into consideration, it is not the case.

Next, results of calculating, in a fiber structure of a typical ring core type (the pattern PR1 shown in FIG. 2), the overlap integral of TM₀₁ mode of each of the fundamental wave and the SH wave and a difference between effective refractive indices of TM₀₁ mode and HE₂₁ mode of each of the fundamental wave and the SH wave based on a full vector wave analysis for a plurality of samples are shown below.

Prepared samples include, as shown in Table 1, samples No. 1 to No. 8, and a difference between effective refractive indices of TM₀₁ mode and HE₂₁ mode of the fundamental wave having a wavelength of 1.064 μm is denoted by Δn_{eff}^{1.06}, a difference between effective refractive indices of TM₀₁ mode and HE₂₁ mode of the SH wave having a wavelength of 0.532 μm is denoted by Δn_{eff}^{0.53}. Further, it is a calculation result with n₀ equal to 1.449679. When the inner radius of the ring portion corresponding to the ring-shaped high refractive index region 112 of the pattern PR2 in FIG. 2 is denoted by r₁(μm), and the outer radius is denoted by r₂ (μm), (1) the ratio (r₁/r₂) of the samples No. 1 to No. 8, (2) the radius ((r₁+r₂)/2) indicating a center position of the ring portion, (3) the width of ring portion (r₂−r₁), (4) the relative refractive index difference Δ, (5) the effective relative refractive index difference Δn_{eff}^{1.06} at the wavelength of 1.064 μm, (6) the effective relative refractive index difference Δn_{eff}^{0.53} at the wavelength of 0.532 μm, (7) the overlap integral of the TM₀₁ mode (I_{TM01}), and (8) the overlap integral of the TM₀₂ mode (I_{TM02}) are set as follows. Note that, in Table 1, as for (8) the overlap integral of TM₀₂ mode, only data of two samples No. 4 and No. 8 are shown.

TABLE 1

| SAMPLE | | | | | | | | |
|---|---|---|---|---|---|---|---|---|
| No. | r₁/r₂ | (r₁ + r₂)/2 | r₂ − r₁ | Δ | Δn_{eff}^{1.06} | Δn_{eff}^{0.53} | (I_{TM01}) | (I_{TM02}) |
| 1 | 0.75 | 2.8 | 0.8 | 1.5 | 11 × 10⁻⁵ | 10 × 10⁻⁵ | 0.80 | 0.00 |
| 2 | 0.75 | 2.8 | 0.8 | 1.0 | 4 × 10⁻⁵ | 5 × 10⁻⁵ | 0.72 | 0.00 |
| 3 | 0.75 | 2.8 | 0.8 | 2.0 | 22 × 10⁻⁵ | 16 × 10⁻⁵ | 0.82 | 0.00 |
| 4 | 0.65 | 2.8 | 1.2 | 1.5 | 12 × 10⁻⁵ | 6 × 10⁻⁵ | 0.86 | 0.011 |
| 5 | 0.81 | 2.8 | 0.6 | 1.5 | 9 × 10⁻⁵ | 12 × 10⁻⁵ | 0.73 | 0.00 |
| 6 | 0.71 | 2.4 | 0.8 | 1.5 | 11 × 10⁻⁵ | 10 × 10⁻⁵ | 0.79 | 0.00 |
| 7 | 0.78 | 3.2 | 0.8 | 1.5 | 11 × 10⁻⁵ | 10 × 10⁻⁵ | 0.79 | 0.00 |
| 8 | 0.65 | 2.8 | 1.2 | 2.0 | 21 × 10⁻⁵ | 9 × 10⁻⁵ | 0.88 | 0.001 |

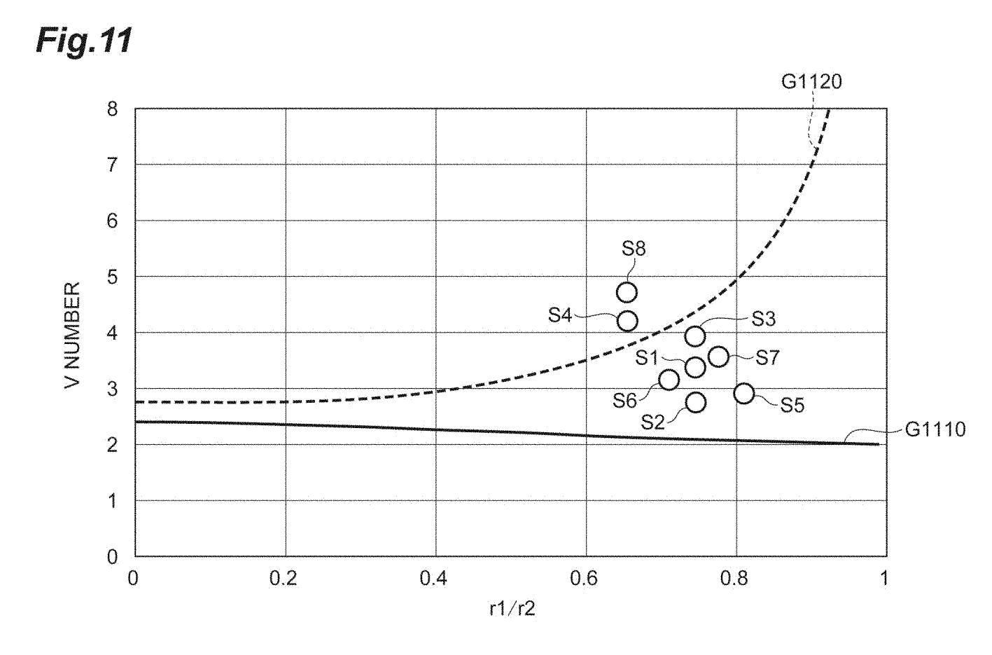

FIG. 11 is a graph in which V numbers of the samples No. 1 to No. 8 are plotted based on the fourth graph in FIG. 10. In FIG. 11, Si to S8 denotes the V numbers of the samples No. 1 to No. 8, respectively.

In the samples No. 4 and No. 8, the overlap integral value of TM₀₁ mode of each of the fundamental wave and the SH wave is as large as about 86% or more, and accordingly the samples No. 4 and No. 8 are effective for wavelength conversion. However, as can be seen from FIG. 11, since the samples No. 4 and No. 8 have a fiber structure that allows existence of TM₀₂ mode, coupling to TM₀₂ mode occurs. However, since the overlap integral is as small as 1.1% or 1.4%, it can be ignored. On the other hand, Δn_{eff}^{1.06} is 0.00012, and Δn_{eff}^{0.53} is 0.00006. The value of Δn_{eff}^{0.53} is smaller than the value of Δn_{eff}^{1.06} and is at a level where no problem arises. However, when Δn_{eff}^{0.53} becomes equal to or less than 0.00005, coupling to HE₂₁ mode becomes strong, which is unsuitable for wavelength conversion. The lower r₁/r₂ is, the stronger the coupling to TM₀₂ mode that is a higher-order mode of the SH wave becomes, indicating that the lower limit of r₁/r₂ is preferably equal to or greater than 0.6.

Further, the sample No. 5 corresponds to a calculation result in a case where the width of the ring portion is the smallest among the samples No. 1 to No. 8. For the sample No. 5, the overlap integral value of TM₀₁ mode of the fundamental wave and the SH wave is 73%, which is smaller than the other conditions. The more r₁/r₂ is, the smaller the overlap integral of TM₀₁ mode becomes, indicating that the upper limit of r₁/r₂ is preferably equal to or less than 0.8.

Estimation of an appropriate range of the V number from the above-described findings results in 2≤V≤5 from the fourth graph in FIGS. 10 and 11.

Note that, assuming that glass (n₀=1.449679) is used as a substrate material, for example, the center position ((r₁+r₂)/2) of the ring portion becomes about (r₁+r₂)/2=2.8 μm. On the other hand, when the refractive index of the substrate material is 1.75, the appropriate center position of the ring portion becomes about 1.45/1.75 times as large as that of the glass substrate. Thus, the center position of the ring portion may be determined in consideration of the refractive index of the substrate material. Note that, as for the samples No. 1, No. 6, and No. 7, it is also understood that the dependence of the center position of the ring portion on a reference position (a position in a case of the glass substrate), which is obtained from the refractive index of the substrate material, is small.

Although the above calculation uses n₀=1.449679, such a design method is applicable to fiber structures having other refractive indices.

Hereinafter, specific aspects of the present embodiment will be organized.

### (Aspect 1)

An optical device comprised of glass containing SiO₂, comprises:

a light-incidence end face adapted to receive light;

a light-emission end face disposed opposite to the light-incidence end face and adapted to output the light; and

a repetitive structure including first sections and second sections alternately arranged from the light-incidence end face toward the light-emission end face, each of the first sections serving as a crystallized region in which a radial polarization-ordered structure is formed, each of the second sections serving as a non-crystallized region.

### (Aspect 2)

An optical device comprised of glass containing SiO₂, comprises:

a light-incidence end face adapted to receive light;

a light-emission end face disposed opposite to the light-incidence end face;

a central low refractive index region extending from the light-incidence end face toward the light-emission end face;

a ring-shaped high refractive index region surrounding the central low refractive index region and having a refractive index higher than that of the central low refractive index region;

a first cladding region surrounding the ring-shaped high refractive index region and having a refractive index lower than that of the ring-shaped high refractive index region; and

a second cladding region surrounding the first cladding region and having a refractive index lower than that of the ring-shaped high refractive index region, and

at least a part of a glass region including the central low refractive index region, the ring-shaped high refractive index region, and the first cladding region includes a repetitive structure including first sections and second sections alternately arranged from the light-incidence end face toward the light-emission end face, each of the first sections serving as a crystallized region in which a radial polarization-ordered structure is formed, each of the second sections serving as a non-crystallized region.

### (Aspect 3)

In the optical device described in the aspect 2, the repetitive structure is provided extending from the central low refractive index region to the first cladding region through the ring-shaped high refractive index region.

### (Aspect 4)

In the optical device described in any one of the aspects 1 to 3, the crystallized regions of the first sections contain a metal element as a glass-crystallization promoting dopant.

### (Aspect 5)

In the optical device described in the aspect 4, the metal element is Ti.

### (Aspect 6)

In the optical device described in any one of the aspects 1 to 3, the crystallized regions of the first sections contain a metalloid element as a glass-crystallization promoting dopant.

### (Aspect 7)

In the optical device described in the aspect 6, the metalloid element is Ge.

### (Aspect 8)

In the optical device described in any one of the aspects 1 to 7, the crystallized regions of the first sections contain a monovalent or bivalent metal element as a devitrification inhibiting dopant.

### (Aspect 9)

In the optical device described in the aspect 8, the monovalent or bivalent metal element is Sr or Ba.

### (Aspect 10)

In the optical device described in any one of the aspects 1 to 9, the repetitive structure has a single repetition period from the light-incidence end face toward the light-emission end face.

### (Aspect 11)

In the optical device described in any one of the aspects 1 to 9, a repetition period of the repetitive structure in a direction from the light-incidence end face toward the light-emission end face is a chirp period, a period that is a combination of a plurality of mutually different single periods, or a period based on a Fibonacci sequence or Barker sequence.

### (Aspect 12)

In the optical device described in any one of the aspects 1 to 11, a length of each of the crystallized regions of the first sections in a direction from the light-incidence end face toward the light-emission end face falls within a range of 1 μm to 1000 μm.

### (Aspect 13)

A method for manufacturing an optical device comprises:

a preparation step of preparing an optical fiber including a light-incidence end face and a light-emission end face disposed opposite to the light-incidence end face, and comprised of glass containing SiO₂, the optical fiber including a central low refractive index region extending from the light-incidence end face toward the light-emission end face, a ring-shaped high refractive index region surrounding the central low refractive index region and having a refractive index higher than that of the central low refractive index region, a first cladding region surrounding the ring-shaped high refractive index region and having a refractive index lower than that of the ring-shaped high refractive index region, and a second cladding region surrounding the first cladding region and having a refractive index lower than that of the ring-shaped high refractive index region, the optical fiber including a doped region doped with a glass-crystallization promoting dopant and provided continuously from the light-incidence end face toward the light-emission end face, in at least a part of a glass region including the central low refractive index region, the ring-shaped high refractive index region, and the first cladding region,

a temperature control step of causing a surface temperature of the optical fiber to fall within a range of 100° C. to 800° C. or a range of 100° C. to 1000° C., and

a section forming step of forming, in the doped region, a repetitive structure including first sections and second sections alternately arranged from the light-incidence end face toward the light-emission end face, each of the first sections serving as a crystallized region in which a radial polarization-ordered structure is formed, each of the second sections serving as a non-crystallized region, by intermittent irradiation of laser light to the doped region in a direction from the light-incidence end face toward the light-emission end face.

### (Aspect 14)

In the method for manufacturing an optical device described in the aspect 13, in the intermittent irradiation of laser light, a laser light source configured to emit pulse laser light is used.

### (Aspect 15)

In the method for manufacturing an optical device described in the aspect 13, in the intermittent irradiation of laser light, a laser light source configured to emit CW laser light is used.

### (Aspect 16)

A wavelength conversion method for causing a radially polarization vector beam to impinge on the optical device described in any one of the aspects 1 to 12.

### REFERENCE SIGNS LIST

100, 200 . . . optical device; 100A . . . optical fiber; 111 . . . central low refractive index region; 112 . . . ring-shaped high refractive index region; 121 . . . first cladding region; 122 . . . second cladding region; 310 . . . laser light source; 161, 210 . . . crystallized region (first section); 162, 220 . . . non-crystallized region (second section); 400 . . . wavelength converter; 410 . . . vector beam light source; 420A, 420B . . . collimating lens; and 450 . . . radially polarization vector beam.

1. An optical device comprised of glass containing SiO₂, comprising:
a light-incidence end face adapted to receive light;
a light-emission end face disposed opposite to the light-incidence end face and adapted to output the light; and
a repetitive structure including first sections and second sections alternately arranged along a center axis extending from a center of the light-incidence end face toward a center of the light-emission end face, each of the first sections serving as a crystallized region having a radial polarization-ordered structure, each of the second sections serving as a non-crystallized region.

2. The optical device according to claim 1, wherein
the optical device comprises an optical fiber including:
a central low refractive index region extending along the center axis;
a ring-shaped high refractive index region surrounding the central low refractive index region and having a refractive index higher than that of the central low refractive index region;
a first cladding region surrounding the ring-shaped high refractive index region and having a refractive index lower than that of the ring-shaped high refractive index region; and
a second cladding region surrounding the first cladding region and having a refractive index lower than that of the ring-shaped high refractive index region, and
the crystallized regions of the first sections are provided in at least a part of a glass region including the central low refractive index region, the ring-shaped high refractive index region, and the first cladding region.

3. The optical device according to claim 2, wherein
each of the crystallized regions of the first sections is provided extending from the central low refractive index region to the first cladding region through the ring-shaped high refractive index region.

4. The optical device according to claim 2, wherein
a ratio (r₁/r₂) of an inner radius r₁ of the ring-shaped high refractive index region to an outer radius r₂ of the ring-shaped high refractive index region falls within a range of 0.6 to 0.8.

5. The optical device according to claim 1, wherein
a V number of each mode with respect to the wave number k₀ of light with the wavelength λ propagating in vacuum falls within a range of 2 to 5, the V number being defined by an expression: k₀*(r₂²−r₁²)^{1/2}*(n₁²−n₀²)^{1/2}.

6. The optical device according to claim 1, wherein
each of the non-crystallized regions of the second sections is an air gap, a region filled with resin having a refractive index equivalent to a refractive index of the crystallized regions of the first sections, or a region filled with oil having a refractive index equivalent to the refractive index of the crystallized regions of the first sections.

7. The optical device according to claim 1, wherein
the crystallized regions of the first sections contain a metal element as a glass-crystallization promoting dopant.

8. The optical device according to claim 7, wherein
the metal element is Ti.

9. The optical device according to claim 1, wherein
the crystallized regions of the first sections contain a metalloid element as a glass-crystallization promoting dopant.

10. The optical device according to claim 9, wherein
the metalloid element is Ge.

11. The optical device according to claim 1, wherein
the crystallized regions of the first sections contain a monovalent or bivalent metal element as a devitrification inhibiting dopant.

12. The optical device according to claim 11, wherein
the monovalent or bivalent metal element is Sr or Ba.

13. The optical device according to claim 1, wherein
the repetitive structure has a single repetition period from the light-incidence end face toward the light-emission end face.

14. The optical device according to claim 1, wherein
a repetition period of the repetitive structure in a direction from the light-incidence end face toward the light-emission end face is a chirp period, a period that is a combination of a plurality of mutually different single periods, or a period based on a Fibonacci sequence or Barker sequence.

15. The optical device according to claim 1, wherein
a length of each of the crystallized regions of the first sections in a direction from the light-incidence end face toward the light-emission end face falls within a range of 1 μm to 1000 μm.

16. A method for manufacturing an optical device, the optical device including a light-incidence end face adapted to receive light, a light-emission end face disposed opposite to the light-incidence end face and adapted to output the light, and a repetitive structure including first sections and second sections alternately arranged along a center axis extending from a center of the light-incidence end face to a center of the light-emission end face, each of the first sections serving as a crystallized region in which a radial polarization-ordered structure is formed, each of the second sections serving as a non-crystallized region, the method comprising:
preparing a glass rod having the light-incidence end face and the light-emission end face, extending along the center axis, containing SiO₂, and including a doped region, the doped region constituting at least a part of a cross section of the glass rod orthogonal to the center axis, being formed over an entire length of the glass rod, and being doped with a glass-crystallization promoting dopant;
controlling temperature to cause a surface temperature of the glass rod to fall within a range of 100° C. to 1000° C.;
irradiating laser light to the doped region to form, in the doped region, portions to be the crystallized regions of the first sections each having the polarization-ordered structure; and
separating portions to be the crystallized regions of the first sections in the doped region by forming portions to be the non-crystallized regions of the second sections at least in the doped region.

17. The method for manufacturing an optical device according to claim 16, wherein
the glass rod includes: an optical fiber including a central low refractive index region extending from the light-incidence end face toward the light-emission end face; a ring-shaped high refractive index region surrounding the central low refractive index region and having a refractive index higher than that of the central low refractive index region; a first cladding region surrounding the ring-shaped high refractive index region and having a refractive index lower than that of the ring-shaped high refractive index region; and a second cladding region surrounding the first cladding region and having a refractive index lower than that of the ring-shaped high refractive index region,
the doped region constitutes at least a part of a glass region including the central low refractive index region, the ring-shaped high refractive index region, and the first cladding region,
the controlling temperature includes keeping a surface temperature of the optical fiber within a range of 100° C. to 800° C.,
the separating portions is a sub-step of the irradiating laser light and includes stopping irradiation of the laser light to the doped region, whereby the irradiating laser light performs intermittent irradiation of laser light to the doped region in a direction from the light-incidence end face toward the light-emission end face to form, in the doped region, a repetitive structure including the crystallized regions of the first sections and the non-crystallized regions of the second sections alternately arranged along the center axis.

18. The method for manufacturing an optical device according to claim 17, wherein
in the intermittent irradiation of laser light, a laser light source configured to emit pulse laser light is used.

19. The method for manufacturing an optical device according to claim 17, wherein
in the intermittent irradiation of laser light, a laser light source configured to emit CW laser light is used.

20. The method for manufacturing an optical device according to claim 16, wherein
the separating portions includes, before or after the irradiating laser light, periodically forming grooves in the glass rod along the center axis to form the portions to be the non-crystallized regions of the second sections.

21. The method for manufacturing an optical device according to claim 20, wherein
the separating portions includes scrapping part of the glass rod using a dicing saw, scrapping the part of the glass rod using a wire saw, or removing the part of the glass rod by dry etching to periodically form the grooves in the glass rod.

22. A wavelength conversion method for causing a radially polarization vector beam to impinge on an optical device according to claim 1.
